(19) United States
(12) Patent Application Publication
(10) Pub. No.: US 2013/0155938 A1
(43) Pub. Date: Jun. 20, 2013

(54) TCP-RELAY FOR WIRELESS APPLICATIONS

(71) Applicants: ROLAND SMITH, NEPEAN (CA); WAICHI LO, KANATA (CA); STEPHEN RAYMENT, OTTAWA (CA)

(72) Inventors: ROLAND SMITH, NEPEAN (CA); WAICHI LO, KANATA (CA); STEPHEN RAYMENT, OTTAWA (CA)

(73) Assignee: BELAIR NETWORKS, Kanata (CA)

(21) Appl. No.: 13/328,642

(22) Filed: Dec. 16, 2011

(51) Int. Cl. H04W 84/02; H04B 7/14

(52) U.S. Cl. 370/315; 370/338

(57) ABSTRACT

A system for improving TCP signal reception comprising a TCP-relay component, a wireless component and an antenna (e.g., a smart antenna) coupled to the wireless component. The system being configured to receive a TCP packet with sequence number “N”, send that packet wirelessly (e.g., using 802.11) to a client, receive the client's wireless ACK indicating that the packet was received, and use the client's ACK as the trigger to send a TCP-Acknowledgement of the TCP sequence number “N”.

### TECHNICAL FIELD

The present invention relates to wireless communication systems. More specifically, the present invention relates to wireless local area networks (“WLAN”), Wi-Fi and picocellular wireless communications systems, including IEEE 802.11 systems.

### BACKGROUND

With the evolution of wireless networks driven by a significant increase in wireless mobile data, and the proliferation of wireless transceivers, spectrum interference is rapidly becoming the limiting factor in determining cell size and coverage.

For Wi-Fi networks, noise from other unlicensed band systems (e.g., other Wi-Fi transceivers, Digital Enhanced Cordless Telecommunications (“DECT”) phones, Bluetooth devices, microwave ovens and other unlicensed devices) generates a level of interference—or “noise floor”—which can be very large in urban areas. For example, measurements made in typical large urban environments show noise floors in the 2.4 GHz ISM band to be in the range of −70 to −80 dBm, or approximately 20 to 30 dB above the theoretical thermal noise floor, which is −103 dBm for 20 MHz wide channels. As a result, Wi-Fi networks operating in these bands will have smaller cells because all transmissions are limited by signal-to-noise ratios (“SNR”), and the Wi-Fi networks are designed to operate only to 0 dB SNR; with maximal ratio combining (“MRC”), Wi-Fi networks may operate with a slightly negative SNR.

Therefore, it would be advantageous for wireless data systems to be designed to operate in an interference-laden environment. Despite the prior attempts, a need still exists for systems and methods that improve data throughput in a lossy radio environment when using, for example, ACKnowledgment (“ACK”) protocols (e.g., Transmission Control Protocol (“TCP”) and Reliable User Datagram Protocol (“RUDP”)).

### SUMMARY OF THE INVENTION

The present disclosure is directed to systems and methods for improving data throughput in a lossy radio environment using acknowledged protocols. More particularly, the present disclosure teaches a system and method for employing both the operation of ACKnowledged data transfer protocols, such as TCP and RUDP, and the operation of an IEEE 802.11 protocol.

According to a first aspect of the present invention, a method for improving TCP signal reception comprises the steps of: receiving a TCP packet having a sequence number N from a server; processing the TCP packet; communicating the TCP packet wirelessly to a client; receiving a wireless-ACK packet from the client wherein the wireless-ACK packet indicates that the TCP packet was received by the client; triggering a TCP-ACKnowledgement packet (“TCP-ACK”) to acknowledge receipt of the TCP packet using the wireless-ACK packet; and communicating the TCP-ACK to the server. The wireless functionality may further comprise communicating the TCP packet and/or receiving the wireless-ACK. In certain aspects of the present invention, an access point's (“AP”) TCP-relay component may perform the steps of: (i) receiving a TCP packet having a sequence number N; (ii) processing the TCP packet; and (iii) communicating the TCP-ACK to the server. In further aspects, the wireless communication is in accordance with IEEE 802.11 standards and may use a smart antenna to improve wireless functionality.

According to a second aspect of the present invention, a system for improving TCP signal reception comprises: a TCP-relay component enabled to receive a TCP packet having a sequence number N from a server, process the TCP packet and communicate a TCP-ACK to the server; a wired component for enabling communication between the TCP-relay component and a network; a wireless component enabled to wirelessly communicate the TCP packet to a client and receive a wireless ACK from the client; and a smart antenna coupled to the wireless component wherein receipt of the wireless ACK from the client is used to trigger communication of the TCP-ACK to the server.

According to a third aspect of the present invention, a processor-based device having improved TCP signal reception comprises: a TCP-relay component enabled to receive a TCP packet having a sequence number N from a server, process the TCP packet and communicate a TCP-ACK to the server; a wired component for enabling communication between the TCP-relay component and a network; a wireless component enabled to wirelessly communicate the TCP packet to a client and receive a wireless ACK from the client; and a smart antenna coupled to the wireless component, wherein receipt of the wireless ACK from the client is used to trigger communication of the TCP-ACK to the server.

According to a fourth aspect of the present invention, a system having improved TCP signal reception comprises: a processor; data storage; a wired connection enabled to receive a TCP packet having a sequence number N from a server and communicate a TCP-ACK to the server; a wireless connection enabled to wirelessly communicate the TCP packet to a client and receive a wireless ACK from the client; and a smart antenna coupled to the wireless connection, wherein receipt of the wireless ACK from the client is used to trigger communication of the TCP-ACK to the server.

In certain aspects, the wireless communication is in accordance with IEEE 802.11 standard and/or the smart antenna may be a switched antenna wherein the switched beam is optimized to improve the reception and/or SNR of the wireless ACK or the smart antenna is a beam-formed antenna wherein the beam-forming is performed to improve the reception and/or SNR of the client's wireless ACK.

### DESCRIPTION OF THE DRAWINGS

These and other advantages of the present invention will be readily understood with reference to the following specifications and attached drawings wherein:

FIG. 1a illustrates a typical 32-bit TCP segment structure;

FIG. 1b illustrates a first system for performing the basic function of TCP transfers using ACK packets;

FIG. 1c illustrates a second system performing the basic function of TCP transfers using ACK packets wherein a single ACK may be used for multiple data transfers;

FIG. 2a is an access point system for improving TCP signal reception;

FIG. 2b is an access point system employing smart antenna functionality for improving TCP signal reception;

FIG. 3a illustrates an access point in communication with a client device and a server;

FIG. 3b illustrates the access point of FIG. 3a in communication with a second access point and a client device; and

FIG. 4 is a flow chart illustrating an exemplary access point process wherein a wireless ACK (e.g., a IEEE 802.11 ACK) may be used to indicate and trigger a TCP-ACK.

### DETAILED DESCRIPTION

Preferred embodiments of the present invention will be described hereinbelow with reference to the accompanying drawings. In the following description, well-known functions or constructions are not described in detail because they may obscure the invention in unnecessary detail. Described herein are a number of steps, methods, and solutions that may be applied to greatly improve TCP signal reception in lossy environments. Specifically, the following embodiments are directed to systems and/or methods capable of employing both the operation of ACKnowledged data transfer protocols such as, for example, TCP and RUDP, and the operation of an IEEE 802.11 protocol. For this disclosure the following terms and definitions shall apply:

The terms “IEEE 802.11” and “802.11” refer to a set of standards for implementing wireless local area network (“WLAN”) computer communication in the 2.4, 3.6 and 5 GHz frequency bands. The set of standards being maintained by the IEEE LAN/MAN Standards Committee (IEEE 802).

The terms “communicate” and “communicating” as used herein include both conveying data from a source to a destination, and delivering data to a communications medium, system, channel, network, device, wire, cable, fiber, circuit and/or link to be conveyed to a destination; the term “communication” as used herein means data so conveyed or delivered. The term “communications” as used herein includes one or more of a communications medium, system, channel, network, device, wire, cable, fiber, circuit and/or link.

The term “processor” as used herein means processing devices, apparatus, programs, circuits, components, systems and subsystems, whether implemented in hardware, tangibly-embodied software or both, and whether or not programmable. The term “processor” as used herein includes, but is not limited to, one or more computers, hardwired circuits, signal modifying devices and systems, devices and machines for controlling systems, central processing units, programmable devices and systems, field programmable gate arrays, application-specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data. The terms “storage” and “data storage” as used herein include, but are not limited to, hard disks, solid state drives, flash memory, DRAM, RAM, ROM, tape cartridges and any other medium capable of storing computer-readable data.

The term “omnidirectional antenna” as used herein means an antenna that radiates radio wave power uniformly in all directions, with the radiated power decreasing with an elevation angle above or below the plane dropping to zero on the antenna's axis, thereby producing a doughnut-shaped radiation pattern.

The term “directional antenna” as used herein means an antenna that radiates greater power in one or more directions, allowing for increased performance on transmission and reception, and reduced interference from unwanted sources.

TCP is one of the core protocols of the Internet Protocol suite—collectively referred to as TCP/IP. TCP provides reliable, ordered delivery of a stream of bytes from a program on a first computer to another program on a second computer. Consequently, TCP is the protocol on which major Internet applications, such as the World Wide Web, e-mail, file transfer, etc., rely.

TCP provides a point-to-point channel for applications that require a reliable communications channel including, for example, Hypertext Transfer Protocol (“HTTP”), File Transfer Protocol (“FTP”) and Telnet. TCP is reliable in that it strives to make three guarantees to the application layer: (i) the destination will receive the data in the order it was sent; (ii) the destination will receive all the data; and (iii) the destination will not receive duplicates of any of the data. Furthermore, TCP is bidirectional in that once a connection is established, a server may reply to a client over the same connection.

Due to its reliability, TCP dominates wired networks. However, the performance of TCP protocols degrades quickly as the path delay between two nodes increases (e.g., between a transmitting and receiving device). Reducing the transmission rate thereby prevents the formation, or accumulation, of additional unwanted congestion. For that reason, TCP performance depends on how quickly feedback information can be returned to the transmitting device.

For instance, a design principle of TCP is that it provides feedback to the transmitting device to reduce its transmission rate when the network is congested. If the up-link autonomous/random bandwidth requests or 802.11 data packets are lost due to interference, then bi-directional protocols such as TCP or RDUP can significantly slow down. TCP, for example, will automatically adjust to the available bandwidth by modifying the rate of data transfer based on the success or failure of transferred packets. If a TCP-ACKnowledgment packet (“TCP-ACK”), which acknowledges the sequence number of the received packets, is lost, then TCP transfers will slow down or stop until the TCP-ACK is received. Therefore, efficiently providing the TCP-ACK is imperative in order to maintain efficient data transfers. For example, according to the TCP standard, the transmitting device reacts to packet loss when either three duplicate ACK packets are received or an ACK timeout occurs.

In a wired network, the level of congestion may be indicated by the packet loss rate where an increase in congestion yields an increase in packet loss. However, in a wireless network, packet loss is not due only to congestion, but also to link loss (e.g., distance, interference, etc.). Although the link layer often provides a retransmission mechanism to reduce the link loss rate, which is described in greater detail below, the link loss rate is still typically much higher than in a wired network.

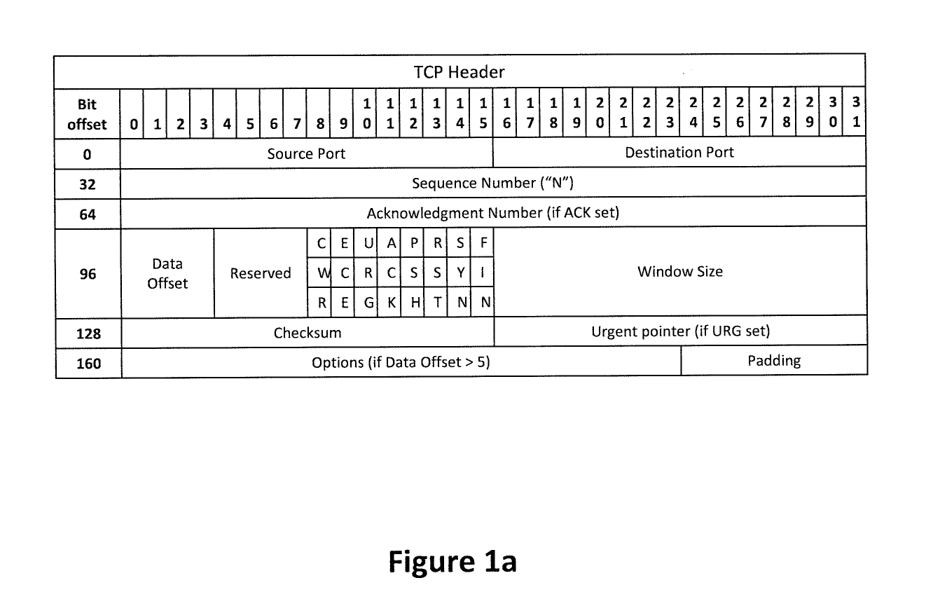

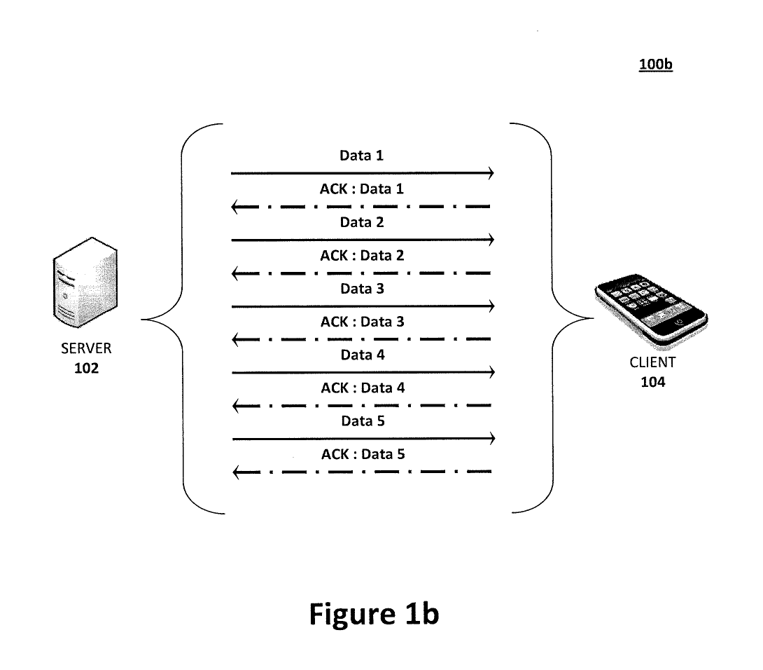

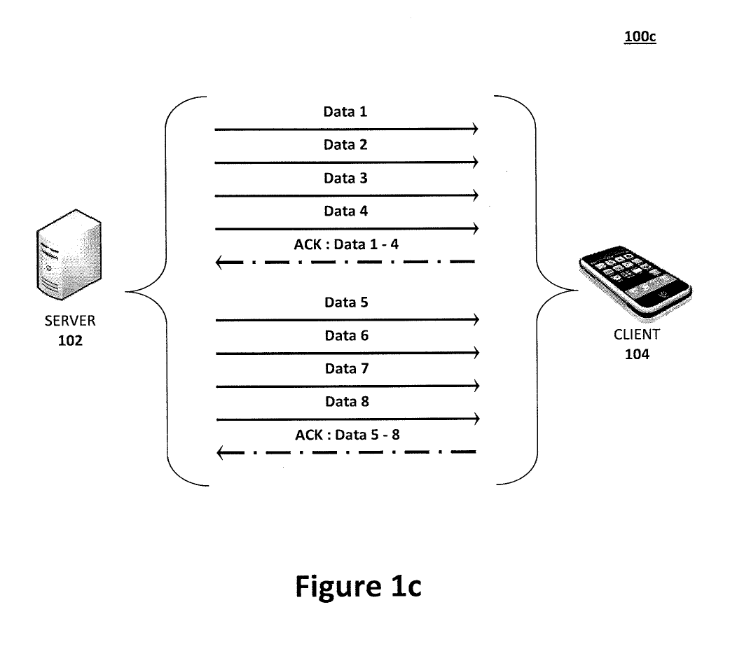

Turning now to the figures, FIG. 1a illustrates a typical 32-bit TCP segment structure. The TCP segment comprises a source port (16 bits) that identifies the sending port as well as a destination port (16 bits) that identifies the receiving port. The TCP segment further comprises a sequence number, represented as “N”, that can serve a dual role. For instance, if the SYN (synchronize sequence numbers) flag is set (1), then this is the initial sequence number. The sequence number of the actual first data byte and the ACK number in the corresponding ACK are then this sequence number plus 1. However, if the SYN flag is clear (0), then this is the accumulated sequence number of the first data byte of this packet for the current session. For further information on sequence numbers and their function, see, for example, “Connected: An Internet Encyclopedia Sequence Numbers” available at http://www.freesoft.org/CIE/Course/Section4/9.htm.

Regarding the ACK number (32 bits), if the ACK flag is set then the value of the ACK number field is the next sequence number that the receiver is expecting (this acknowledges receipt of all prior bytes, if any). The first ACK sent by each end acknowledges the other end's initial sequence number itself, but no data. Data offset (4 bits) specifies the size of the TCP header in 32-bit words. The minimum size header is 5 words and the maximum is 15 words, thus giving the minimum size of 20 bytes and maximum of 60 bytes, allowing for up to 40 bytes of options in the header. This field gets its name from the fact that it is also the offset from the start of the TCP segment to the actual data. The reserved (4 bits) field is presently designated for future use and should be currently set to zero.

The TCP segment further comprises 8 1-bit flags (8 bits total) including: (i) a Congestion Window Reduced (“CWR”) flag that is set by the sending host to indicate that it received a TCP segment with the ECE flag set and had responded in congestion control mechanism (added to header by RFC 3168); (ii) an ECN-Echo (“ECE”) flag to indicate: (a) if the SYN flag is set (1), that the TCP peer is Explicit Congestion Notification (“ECN”) capable, and (b) if the SYN flag is clear (0), that a packet with Congestion Experienced flag in IP header set is received during normal transmission (added to header by RFC 3168); (iii) an URG flag to indicate that the Urgent pointer field is significant; (iv) an ACK flag to indicate that the Acknowledgment field is significant (all packets after the initial SYN packet sent by the client should have this flag set); (v) a Push function (“PSH”) flag asks to push the buffered data to the receiving application; (vi) a RST flag resets the connection; (vii) a Synchronize sequence numbers (“SYN”) flag—only the first packet sent from each end should have this flag set (some other flags change meaning based on this flag, and some are only valid for when it is set, and others when it is clear); and (viii) a FIN flag to indicate that there is no more data from the sender.

Window size (16 bits) represents the size of the receive window, which specifies the number of bytes (beyond the sequence number in the acknowledgment field) that the receiver is currently willing to receive (see Flow control and Window Scaling below). Checksum (16 bits) is used for error-checking of the header and data. Urgent pointer (16 bits), if the URG flag is set, indicates this 16-bit field is an offset from the sequence number indicating the last urgent data byte

Options are variable 0-320 bits, divisible by 32. The length of the options field is determined by the data offset field. Options 0 and 1 are a single byte (8 bits) in length. The remaining options indicate the total length of the option (expressed in bytes) in the second byte. The TCP header padding is used to ensure that the TCP header ends and data begins on a 32-bit boundary and is merely composed of zeros.

As noted above, to ensure timely and accurate packet delivery, wireless data systems designed to operate in an interference environment may include packet retransmission protocols. These retransmission protocols enable a wireless data packet to be retransmitted multiple times until the system has received confirmation that the data packet has been received. Retransmission protocols may also adjust parameters (e.g., forward error correction (“FEC”), modulation rate, antenna selection, etc.) in order to receive a positive ACK that the transmitted packet was received by the far end device. For example, in the case of IEEE 802.11 wireless standards, a positive ACK is transmitted after (e.g., within a defined window of time, sometimes immediately) the transmitted data packet was properly received. However, if an ACK is not received, then the wireless data system may continue to retransmit the packet, up to a defined number of attempts, and possibly employ techniques (e.g., adjust parameters) for increasing the likelihood that the packet will be received and ACKnowledged.

In a re-transmission procedure, IEEE 802.11 radio devices often rely on a preset ACK timeframe. Accordingly, if a transmitting device does not receive an ACK response from the receiving device within a preset ACK timeframe, the transmitting device will assume that the packet has been lost and may proceed to retransmit the packet until an ACK is received. The ACK timeframe may vary depending on, for example, the device, operating conditions, interference levels and the distance between the transmitting and receiving device (e.g., nodes). In the case of a long-range link, the time to send a message and receive an ACK response generally increases with distance and may exceed the preset ACK timeframe. For instance, when sending multiple packets, the throughput can be greatly delayed if the transmitting device is continuously re-transmitting due to the ACK not being timely received by the transmitting device, effectively losing throughput. Therefore, on long-range links, increasing the ACK timeframe can reduce the occurrence of retransmits thereby improving the quality of the link. However, in the case of shorter links, a high ACK timeframe may cause the transmitting device to wait too long before re-transmitting the packet when the first packet was, in fact, lost in transit, thereby decreasing throughput. Accordingly, the ACK timeframe should be adjusted based on the length of the link and other variables.

To address this, the IEEE standard provides exemplary guidelines and constants that may be used to calculate ACK timeframes. For further information on ACK timeframe calculations, see, for example, ACK Timeouts and the Effects on Distance Links, available at http://www.air-stream.org/ACK Timeouts. Accordingly, an ACK timeframe may be calculated or chosen using techniques known in the art of data transmission, including, but not limited to, those governed, or recommended, by the IEEE standard.

Turning now to FIG. 1b, the figure illustrates an exemplary system 100b performing the basic function of TCP transfers using ACK functionality. In operation, when a server 102 transmits one or more data segments to a client 104, the client 104 transmits an ACK confirmation reply back to the server 102 confirming receipt of said one or more data segments. As illustrated, after each data segment transmission from the server 102 to the client 104, the client returns an ACK identifying the received data. This process ensures that the client 104 receives all intended data segments in the correct order while preventing duplicate data transmissions. In the event the server 102 does not receive an ACK from the client 104, the server 102 may retransmit the data until it has either (i) received an ACK or (ii) a timer has signaled a “time out” flag (e.g., based on number of attempts or duration of time). However, to increase transmission rate and/or efficiency of the ACK protocol, the system 100b may be configured to employ a single confirmation reply for a plurality of TCP segments.

FIG. 1c exemplifies a system 100c for communicating an ACK to the server 102 that includes a single ACK confirmation reply for a plurality of TCP segments, thus allowing efficient transmission of the ACK. For example, in operation, when server 102 transmits data segments DATA 1, DATA 2, DATA 3, DATA 4 to a client 104, the client 104 may transmit a single ACK confirmation reply back indicating that data segments DATA 1, DATA 2, DATA 3, DATA 4 have been received. Accordingly, server 102 may then transmit data segments DATA 5, DATA 6, DATA 7, DATA 8 to a client 104. Upon receipt, client 104 may transmit a second ACK confirmation reply back indicating that data segments DATA 5, DATA 6, DATA 7, DATA 8 have been received. As in the system 101b of FIG. 1b, in the event the server 102 does not receive an ACK from the client 104, the server 102 may retransmit the data until it has either (i) received an ACK or (ii) a timer has signaled a “time out” flag (e.g., based on number of attempts or duration of time).

In certain situations, a relay apparatus may be used to relay a packet from a first point to a second point. For example, packets may be relayed from a home Internet terminal to an ISP (Internet Service Provider) or vice versa. U.S. Patent Publication No. 2009/0183252 to Motohide Nomi, entitled “Packet Relay Apparatus,” discloses an exemplary packet relay apparatus for reducing the number of packets to be transferred from hardware to a CPU by keeping only packets specified as authentication target packets of MAC address authentication.

Likewise, the paper entitled “Application Layer Relays For Wireless 802.11 Mesh Networks” by Huang et al. (the “Huang article”) compares the performance of a TCP relay system to a system without relays. An objective of the Huang article is to increase the successful receiving rate at the destination (e.g., the “goodput,” which is defined as the amount of useful information, in kbps, being received by the receiver per second, not including errors). More specifically, as a solution in the wired world to improve the TCP performance, the Huang article discusses an application layer relay method that splits a traditional end-to-end TCP connection into several short hop connections. The Huang article also found that relays with scheduling can achieve up to 50% performance gain in a 4-hop network.

As discussed by the Huang article, when a TCP packet passes through a relay node, the relay node keeps a local copy of the packet and sends an ACK packet immediately to the previous hop. Meanwhile, the relay node sends the local copy to the next hop via another TCP connection. The received copy is deleted when the next hop successfully receives it. If the packet is lost while it is being forwarded to the next hop, the packet will be retransmitted by the relay node, not the original sender. The Huang article notes that the benefits of an application layer TCP relay include, for example: (i) retransmission of any lost packet is local to save unnecessary retransmissions over the intermediate hops; (ii) the round-trip time (“RTT”) becomes smaller as the number of hops of a TCP session is reduced thereby accelerating the feedback process because TCP connections in series react much faster to the packet loss than a single end-to-end connection; and (iii) smaller RTTs and multiple TCP connections increase channel utilizations.

The Huang article also discloses techniques for improving 802.11 transfers using TCP-relaying methods in that the TCP-relay may treat the wireless side more rigorously than the wired side by, for instance, sending additional packets.

As disclosed herein, the reception of an wireless ACK packet may be used to trigger, via TCP-relay, the TCP-ACK on the wired side (e.g., over a network to a server), therefore eliminating the need to receive the actual TCP-ACK, thus increasing efficiency of the system. In essence, the present application integrates wireless ACK (e.g., 802.11 ACK) packet functionality, which acknowledges the reception of an 802.11 packet containing TCP, RUDP or other protocols, to simulate the TCP or RUDP ACK. In operation, the system makes an assumption that if an wireless ACK packet is received by the access point (“AP”) from the client, then the encapsulated Ethernet packet from the server must have been received by the AP. Therefore, the encapsulated Ethernet packet may be acknowledged in advance of receiving an actual TCP-ACK packet, therefore increasing efficiency and eliminating the need for the actual TCP-ACK packet. In essence, the TCP-relay function can use input from the 802.11 transceiver (e.g., that an wireless ACK packet has been received for a specific TCP packet) to spoof the system into believing a TCP-ACK packet has been received.

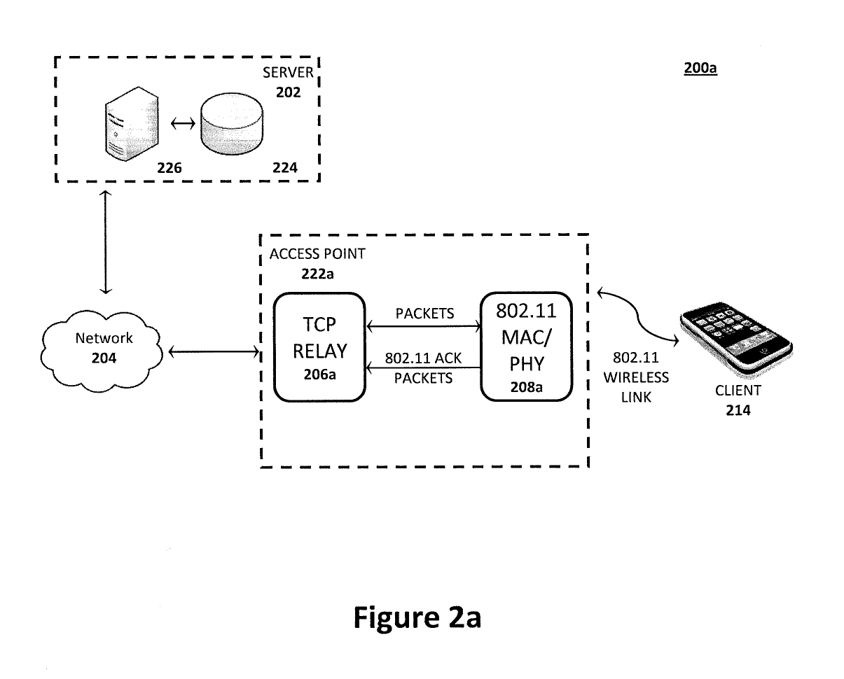

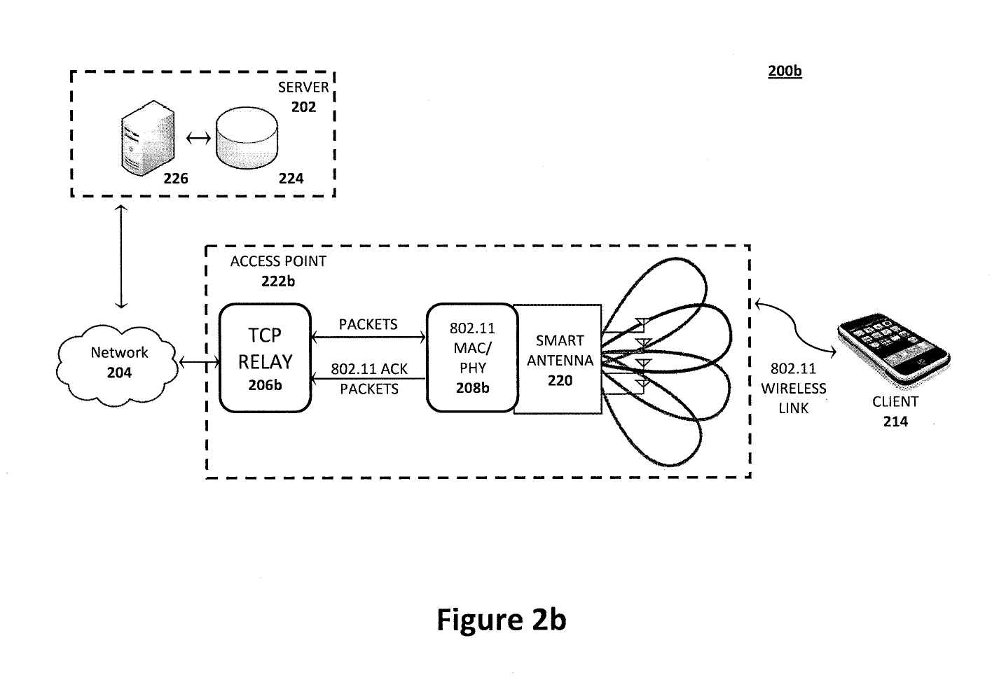

Therefore, the system and method of the present embodiment generally incorporates two functions: (i) a TCP-relay function; and (ii) an 802.11 MAC function. Referring now to FIG. 2a, an exemplary AP system for improving TCP signal reception is shown. The AP system 200a comprises a server 202, a network 204 (e.g., the internet), an AP 222a, and a client 214. The AP 222a generally comprises TCP-RELAY functionality 206a, and an 802.11 MAC functionality component 208a. The server 202 generally comprises a computer 226 (e.g., a processor-based device) coupled to data storage 224. These functions will be performed in AP structure to be described below in more detail.

The TCP-RELAY functionality 206a handles communication between the 802.11 MAC/PHY functionality component 208a and an end server 202, typically over a network 204, while the 802.11 MAC functionality component 208a provides the over-the-air operation (e.g., via an 802.11 wireless link) to a client 214. The 802.11 wireless link may be broken into two main layers: the Media Access Control (“MAC”) layer and the Physical Layer (“PHY”). These two layers permit functional separation of the IEEE 802.11 standard and allow a single data protocol to be used with several different RF transmission techniques. The MAC layer provides addressing and channel access control mechanisms that make it possible for several terminals or network nodes to communicate within a multi-point network, typically a LAN or metropolitan area network (“MAN”). The PHY layer instead defines the different RF transmission techniques: Frequency Hopping Spread Spectrum or FHSS, Direct Sequence Spread Spectrum or DSSS, Diffuse Infrared and Orthogonal Frequency Division Multiplexing or OFDM.

The system of FIG. 2a illustrates a data interface between the TCP-RELAY function 206a and the 802.11 MAC functionality component 208a that not only includes the exchange of data packets, but also allows communication to the TCP-RELAY function 206a of an additional wireless ACK indication that a packet has been ACKnowledged by the client 214 (e.g., a wireless device).

However, in some cases the system of FIG. 2a may only yield a modest improvement in overall throughput performance. This somewhat modest improvement can be attributed to the fact that most outdoor AP systems are “up-link” limited, meaning that they have reduced link budgets in the client-to-AP direction when compared to the AP-to-client direction. In this case, the likelihood of the wireless ACK packet being received, and the TCP-ACK not being received, is small, hence performing the additional functions of a TCP-relay which acknowledges to the server packets (e.g., TCP-ACK packet) which have been received (e.g., using a 802.11/wireless ACK) will provide a small improvement in latency, since the wireless ACK may be received slightly in advance of the TCP-ACK.

To address this, in addition to superior protocols and relaying techniques, other techniques may be further employed to improve the likelihood and rate of a successful transmission. For example, it may be advantageous to also employ a smart antenna system that may be in communication with the 802.11 MAC functionality component.

As disclosed herein, the present systems and methods may take advantage of new technology in the field of smart antennas, which often use (i) beam-forming or (ii) beam-steering techniques. Smart antennas are, generally speaking, antenna arrays with smart signal-processing algorithms used to identify spatial signal signatures, such as a signal's direction of arrival (“DOA”), and to calculate beam-forming vectors to track and locate the antenna beam on the mobile/target. Smart antennas and/or antenna systems may be used to improve Wi-Fi and pico-cellular operation in an interference-limited environment (e.g., an environment with higher levels of interference). Therefore, an objective of such smart antenna systems is to improve the SNR of a signal, thereby increasing effective data communication. As is known in the art, SNR refers to the comparison of the level of a desired signal to the level of background noise, and is defined as the ratio of signal power to the noise power. For example, an SNR value greater than 1:1 indicates that there is more signal than noise. A factor to consider is that SNR issues often arise at an AP, which is especially true for outdoor APs, where the AP is usually located high on a pole or mounted to a wall, thereby being exposed to much higher signal levels, including from interference sources.

Beam-forming, a first targeting technique that may be used with 802.11 systems, refers to a method used to create a particular radiation pattern of the antenna array by adding constructively the phases of the signals in the direction of the targets/mobiles desired, and nulling the pattern of the targets/mobiles that are undesired/interfering targets. This may be accomplished using, for instance, a simple finite-impulse response (“FIR”) tapped delay line filter. Using this technique, the weights of the FIR filter may also be changed adaptively, and be used to provide optimal beam-forming, in the sense that it reduces the minimum mean square error (“MMSE”) between the desired and actual beam pattern formed. In essence, using this process, a beam may be formed by modifying the phase and amplitude of the RF signals sent to the antennas. For additional information related to beam-forming and beam-forming techniques, see, for example, Andy Ganse's articles An Introduction to Beam-forming, Applied Physics Laboratory, University of Washington, Seattle, available at http://staffwashington.edu/aganse/beam-forming/beam-forming.htm.

Beam-steering, on the other hand, involves changing the direction of the main lobe of a radiation pattern—in effect steering the antenna's direction. Beam-steering may be accomplished by switching antenna elements, changing the relative phases of the RF signals driving the elements and/or using an electrical and/or mechanical means to point to a desired direction. For example, an exemplary beam-steering method using parasitic elements is disclosed by P. K. Varlamos and C. N. Capsalis, Electronic Beam-steering Using Switched Parasitic Smart Antenna Arrays, Progress in Electromagnetics Research, PIER 36, 101-119, 2002.

An early small linearly polarized adaptive array antenna for communication systems is disclosed by U.S. Pat. No 4,700,197 to Robert Milne (the “Milne patent”), entitled “Adaptive Array Antenna” (the “Milne antenna”). As discussed in the Milne patent, the directivity and pointing of the Milne antenna's beam may be controlled electronically in both the azimuth and elevation planes. The Milne patent notes that the Milne antenna was found to have a low RF loss and operated over a relatively large communications bandwidth. As disclosed in the Milne patent, the Milne antenna consists, essentially, of a driven λ/4 monopole surrounded by an array of coaxial parasitic elements, all mounted on a ground plane of finite size. The parasitic elements may be connected to the ground plane via PIN diodes or equivalent switching means. By applying suitable biasing voltage, the desired parasitic elements could be electrically connected to the ground plane and made highly reflective, thereby controlling the radiation pattern of the antenna. While the Milne patent illustrates an exemplary smart antenna, virtually any antenna capable of targeting a client device may be used. Similarly, the number and location of the parasitic elements used in the array may be customized for a particular application. For example, a greater number of parasitic elements may be located in one location of the array to better aim the beam.

In an interference-limited environment, new innovative smart antenna systems are able to dynamically steer their antenna beam to point toward client device, thereby improving the SNR seen at the client devices. In a case such as 802.11 Wi-Fi systems, where a positive packet transmission is followed by receiving an ACK packet, the smart antenna system can be held pointing at the client until the ACK is received. If the smart antenna system is able to significantly improve the SNR seen by the client, the smart antenna may be held in the same direction while the ACK is being received to significantly improve the SNR of the received ACK.

This has the advantage of improving the down link throughput—from the wireless data system with the smart antenna, to the client device, usually a laptop or wireless mobility device. For data transfers such as unacknowledged data protocol (“UDP”), these “point and shoot” smart antenna systems can yield improved data throughput. The additional SNR improvements on the delivered packets and on the received ACK will yield corresponding increases in data throughput. However, because these smart antenna systems usually have multiple clients, it may not be possible for the antenna to remain pointed at a particular client device for an extended period. Rather, the system may return to some form of lower gain “omnidirectional” or “directional” antenna mode where the antenna gain, and therefore the resulting achieved SNR, is reduced from the SNR which is achieved which the antenna is steered and pointed at the client.

As shown in FIG. 2b, a smart antenna 220 may be integrated with the system 200a of FIG. 2a to significantly improve the reception of the wireless ACK packet since the antenna beam may directed at the client 214 during the transmission of the 802.11 packet and remain pointed to receive the client's wireless ACK packet. Thus, for most of the internet high throughput applications—such as streaming video, peer-to-peer sharing and browsing applications—where most of the traffic is sent from the AP 222b to the client device 214, the high gain of the smart antenna system ensures not only that the packet is transferred to the client 214, but also that the wireless ACK and the TCP-ACK is received.

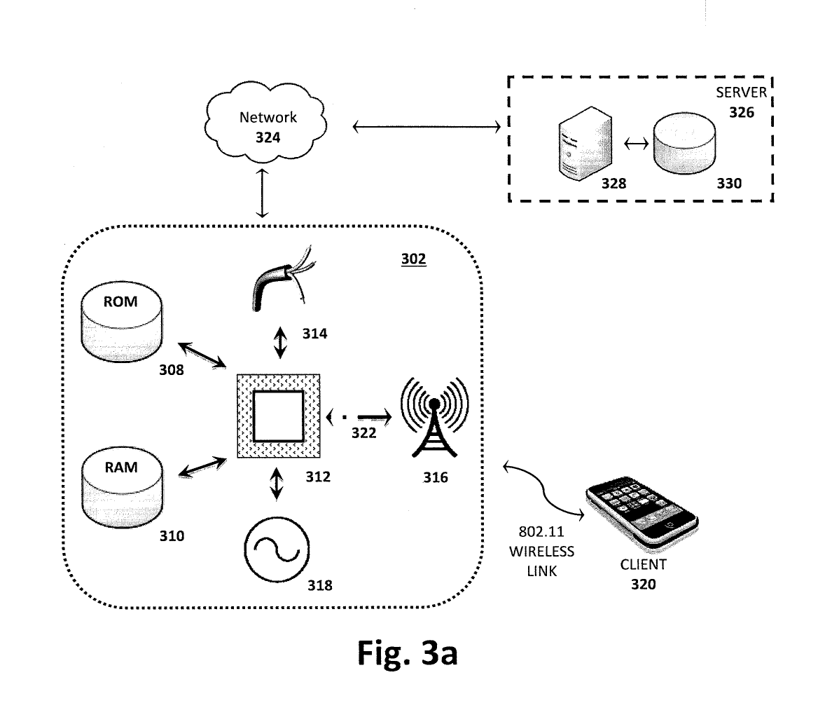

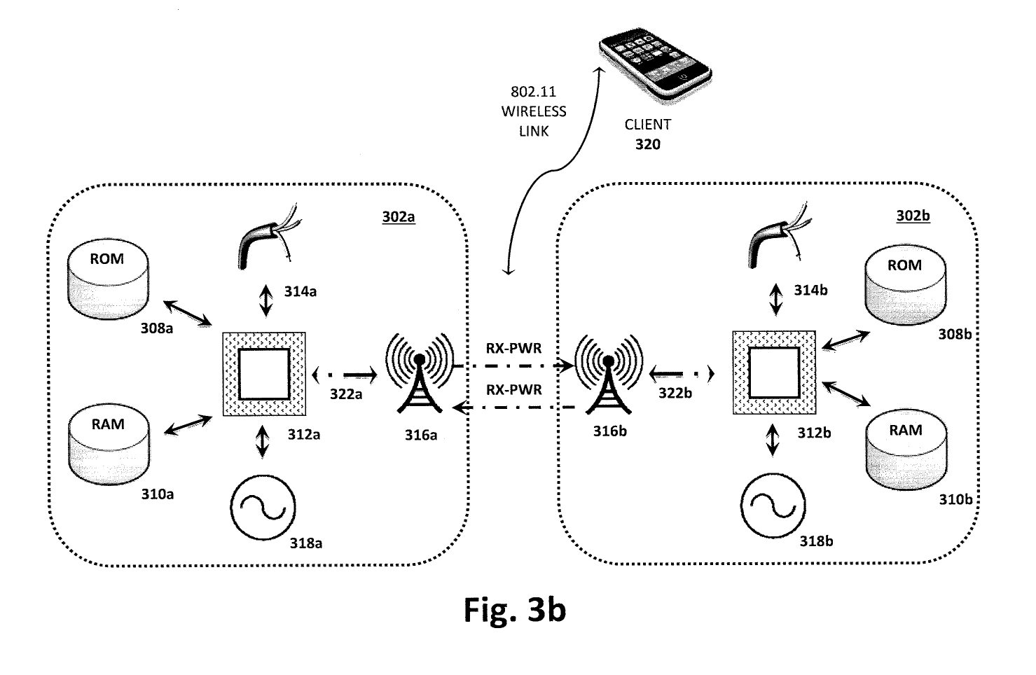

Referring now to FIG. 3a, an exemplary AP 302 may comprise a processor 312, power supply 318, antenna 316, wired communication link 314, wireless connection interface 322 (e.g., RF transceiver, RF front end, etc.), and data storage including, for example, RAM 310 and ROM 308. As depicted in the figure, the AP 302 may communicate with a client 320 (e.g., a wireless device) using an over-the-air wireless link (e.g., via an 802.11 wireless link) and with a server 326 via the wired communication link 314 over a network 324. The server 326 generally comprises a computer 328, such as a processor-based device, coupled to data storage 330.

The antenna 316 may be a traditional antenna or, more preferably, a smart antenna. The wired connection 314 may be enabled to receive a TCP packet having a sequence number N from the server 326, and to communicate a TCP-ACK to the server 326. The wireless connection 322 may be enabled to wirelessly communicate the TCP packet from the server 326 to a client 320, via AP 302, and receive a wireless-ACK (e.g., 802.11 ACK) from the client 320 using, for example, a smart antenna 316 coupled to the wireless connection 322. In operation, receipt of the wireless-ACK from the client 320 may be used by the AP 302 to trigger communication of the TCP-ACK to the server 326, thereby increasing efficiency.

Referring now to FIG. 3b, two identical APs 302a and 302b, as described in FIG. 3a, are illustrated in communication with one another and at least one client 320. As illustrated, an AP 302a is not limited to wireless communication with a client 320, but rather AP 302a may wirelessly communicate with another AP 302b and/or a client 320. While APs 302a 302b are illustrated as being identical to the AP 302 of FIG. 3a, they need not be in order to communicate. In fact, data collected or created by the AP 302a may also be communicated to another AP 302b, client 320 or any other device capable of wired or wireless communication. In certain embodiments, AP 302a may even communicate with AP 302b or a client device 320 using a wired communication link 314a in addition to, or in lieu of, the antenna 316a and wireless interface 322a.

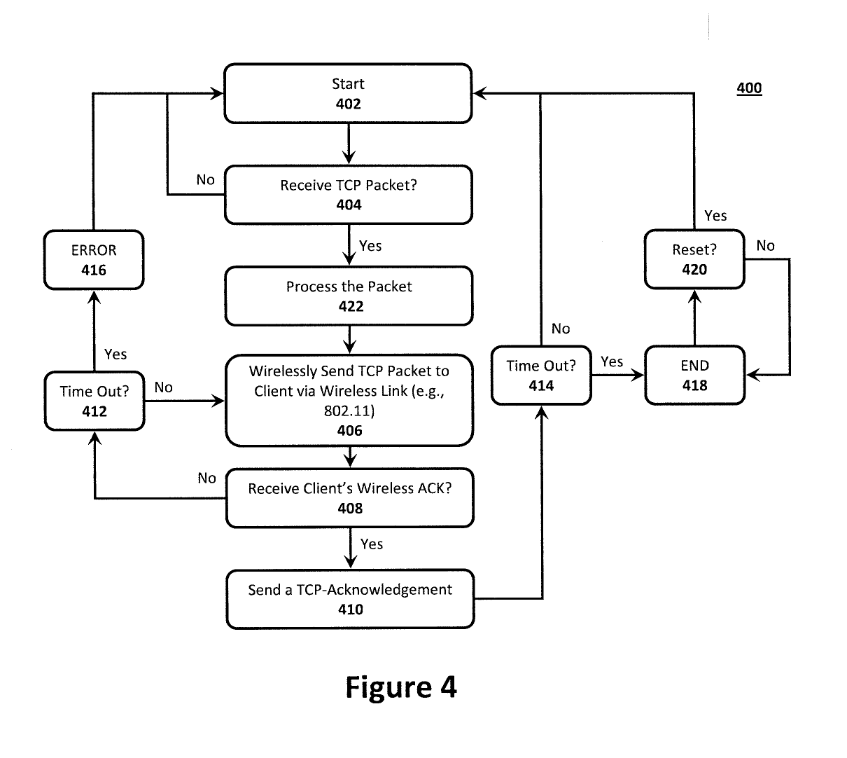

FIG. 4 is a flow chart illustrating an exemplary AP's process 400 wherein an wireless ACK (e.g., 802.11 ACK) may be used to indicate and trigger a TCP-ACK via, for example, a TCP-relay. The AP's process(es) are typically carried out by the AP's processor but may be performed by one or more processors associated with or coupled to each AP. The AP's process starts at step 402. At step 404, the AP determines whether a TCP packet has been received via, for example, the TCP-relay. If a TCP packet has not been received, the AP returns to step 402. However, if a TCP packet has been received, the AP proceeds to step 404 where the packet and/or sequence number are processed at step 422. The AP may then proceed to step 406 where the AP wirelessly sends the received TCP packet to the designated client using, for example, an 802.11 MAC/PHY wireless component. To enhance wireless functionality, a smart antenna would preferably be coupled to the MAC/PHY wireless component. The smart antenna may be, for instance, either (i) a switched antenna or (ii) a beam-formed antenna. In either case, the reception / SNR of the wireless ACK from the client would be improved. At step 408, the AP determines whether an wireless ACK has been received from the client in response to the transmission of the received TCP packet.

If the AP has not received the wireless ACK within a preset number of seconds, the AP will return to step 406 and attempt to retransmit the TCP packet. This cycle may repeat until the AP has either (i) received the ACK at step 408 or (ii) a timer has signaled a “time out” flag at step 412. The timer may signal a time out flag when, for example, a preset number of transmission attempts (e.g., 1-10 attempts, more preferably 1-5 attempts, most preferably 3-5 attempts) have been met or a preset duration of time has elapsed from initial transmission. If a time out flag is indicated at step 412, the AP returns to the start position at step 402. In certain embodiments, an error may be flagged at step 416 to indicate that the AP did not receive an ACK from the client acknowledging receipt of one or more packets. The errors may be recorded to, for example, a data file and/or presented to an AP user via, for example, an audio and/or visual interface or other suitable alerting mechanism.

If the AP has received the wireless ACK at step 408, a TCP-ACK is returned to the server at step 410 to indicate that the packet from the server has been received by the AP. This technique is based on the assumption that if an wireless ACK packet is received from the client, then the packet from the server must have been received by the AP, and therefore can be acknowledged in advance of receiving an actual TCP-ACK, which, as discussed above, typically delays the process by slowing down or stopping transmission until the acknowledgment is received.

Once the TCP-ACK has been returned to the server at step 410, the AP may return to step 402 where the process can repeat with, for instance, another data packet transmission. However, the process may be terminated if a timer has signaled a time out flag at step 414. The timer may signal a time out flag when, for example, a preset number of packets have been transmitted, a preset duration of time has elapsed, all data packets have been transmitted, and/or the process has been otherwise terminated by, for instance, a user or another system or device.

If a time out flag is indicated at step 414, the AP proceeds to the end position at step 418. The system may, however, be reset at step 420, thereby causing the AP to return to step 402. The system may be automatically reset using, for example, software, timers and/or counters or manually reset by a user or another system or device.

Accordingly, as illustrated in FIG. 4, a method for improving TCP signal reception may comprise the steps of: receiving a TCP packet from a server 404; processing the TCP packet 422; communicating the TCP packet wirelessly to a client 406; receiving a wireless-ACK packet from the client wherein the wireless-ACK packet indicates that the TCP packet was received by the client 408; using the wireless-ACK packet to trigger a TCP-ACK packet to acknowledge receipt of the TCP packet; and communicating the TCP-ACK to the server 410 in response to the trigger.

While the foregoing steps may be performed by multiple parts or components within the AP, a number of functions would be preferably performed by the TCP-relay. For instance, the following steps would preferably be performed using the TCP-relay component: (i) receiving the TCP packet; (ii) processing the packet and/or sequence number at step 422; and (iii) replying with an acknowledgement based on reception of the wireless ACK at step 410.

The above-cited patents and patent publications are hereby incorporated by reference in their entirety herein. Although various embodiments have been described with reference to a particular arrangement of parts, features and the like, these are not intended to exhaust all possible arrangements or features, and indeed many other embodiments, modifications and variations will be ascertainable to those of skill in the art. Thus, it is to be understood that the invention may therefore be practiced otherwise than as specifically described above.

What is claimed is:

1. A method for improving TCP signal reception comprising the steps of:
receiving a TCP packet from a server;
processing the TCP packet;
communicating the TCP packet wirelessly to a client;
receiving a wireless-ACK packet from the client wherein the wireless-ACK packet indicates that the TCP packet was received by the client;
using the wireless-ACK packet to trigger a TCP-ACK packet to acknowledge receipt of the TCP packet; and
communicating the TCP-ACK to the server.

2. The method of claim 1 wherein the wireless communication is in accordance with IEEE 802.11 standards.

3. The method of claim 1 further comprising the step of using a smart antenna to improve wireless functionality.

4. The method of claim 3 wherein the wireless functionality comprises communicating the TCP packet and/or receiving the wireless-Acknowledgement.

5. The method of claim 3 wherein the smart antenna is a switched antenna and the switched beam is optimized to improve the reception and/or SNR of the wireless-ACK by holding the switched beam at the client after transmission until the ACK is received.

6. The method of claim 3 wherein the smart antenna is a beam-formed antenna, and the beam-forming is performed to improve the reception and/or SNR of the client's wireless-ACK by holding the beam at the client after transmission until the ACK is received.

7. A system for improving TCP signal reception comprising:
a TCP-relay device enabled to receive a TCP packet having a sequence number N from a server, process the TCP packet and communicate a TCP-ACK to the server;
a wired component for enabling communication between the TCP-relay component and a network;
a wireless component enabled to wirelessly communicate the TCP packet to a client, receive a wireless-ACK from the client; and
a smart antenna coupled to the wireless component;
wherein receipt of the wireless-ACK from the client is used to trigger communication of the TCP-ACK to the server.

8. The system of claim 7 wherein the wireless communication is in accordance with IEEE 802.11 standards.

9. The system of claim 7 wherein the smart antenna is a switched antenna and the switched beam is optimized to improve the reception and/or SNR of the wireless-ACK.

10. The system of claim 7 wherein the smart antenna is a beam-formed antenna, and the beam-forming is performed to improve the reception and/or SNR of the client's wireless-ACK.

11. A processor-based device having improved TCP signal reception comprising:
a TCP-relay device enabled to receive a TCP packet having a sequence number N from a server, process the TCP packet and communicate a TCP-ACK to the server;
a wired component for enabling communication between the TCP-relay component and a network;
a wireless component enabled to wirelessly communicate the TCP packet to a client, receive a wireless-ACK from the client; and
a smart antenna coupled to the wireless component;
wherein receipt of the wireless-ACK from the client is used to trigger communication of the TCP-ACK to the server.

12. The processor-based device of claim 11 wherein the wireless communication is in accordance with IEEE 802.11 standards.

13. The processor-based device of claim 11 wherein the smart antenna is a switched antenna and the switched beam is optimized to improve the reception and/or SNR of the wireless-ACK.

14. The processor-based device of claim 11 wherein the smart antenna is a beam-formed antenna, and the beam-forming is performed to improve the reception and/or SNR of the client's wireless-ACK.

15. A system having improved TCP signal reception comprising:
a processor;
data storage;
a wired connection enabled to receive a TCP packet having a sequence number N from a server, and communicate a TCP-ACK to the server;
a wireless connection enabled to wirelessly communicate the TCP packet to a client and receive a wireless-ACK from the client; and
a smart antenna coupled to the wireless connection;
wherein receipt of the wireless-ACK from the client is used to trigger communication of the TCP-ACK to the server.

16. The system of claim 15 wherein the system is further enabled to communicate with other processor based systems.

17. The system of claim 15 wherein the wireless communication is in accordance with IEEE 802.11 standards.

18. The system of claim 15 wherein the smart antenna is a switched antenna and the switched beam is optimized to improve the reception and/or SNR of the wireless-ACK.

19. The system of claim 15 wherein the smart antenna is a beam-formed antenna, and the beam-forming is performed to improve the reception and/or SNR of the client's wireless-ACK.
